(19) United States
(12) Patent Application Publication
(10) Pub. No.: US 2017/0098220 A1
(43) Pub. Date: Apr. 6, 2017

(54) METHOD FOR SECURING AN ELECTRONIC TRANSACTION REQUEST FROM A COMPUTING DEVICE FOR FRAUD DETECTION

(71) Applicant: MasterCard International Incorporated, Purchase, NY (US)

(72) Inventors: Jaipal Singh KUMAWAT, Sikar (IN); Gurpreet ATWAL, Somers, NY (US); Hemant ARORA, Gurgaon (IN)

(73) Assignee: MasterCard International Incorporated, Purchase, NY (US)

(21) Appl. No.: 15/217,113

(22) Filed: Jul. 22, 2016

(30) Foreign Application Priority Data
Jul. 24, 2015 (SG) 10201505791P

(51) Int. Cl. G06Q 20/40; H04L 29/08; G06Q 20/20; H04L 29/12

(52) U.S. Cl. CPC G06Q 20/4016; H04L 61/6022; H04L 67/18; H04L 61/2007; G06Q 20/20; G06Q 20/409

(57) ABSTRACT

A method is disclosed for performance by at least one server, for securing an electronic transaction request from a computing device for fraud detection. The request is received as a data packet comprising at least identification data of a payment card associated with the transaction and a MAC address of the computing device, is disclosed. The method comprises the server comparing the MAC address with at least a first list of MAC addresses to obtain a first determination; the server using the identification data to obtain at least one second determination; and the server transmitting a response to the computing device to accept or decline the request based on the first determination and the at least one second determination. A related computing device and server are also disclosed.

### FIELD OF THE INVENTION

The present invention relates to methods for securing an electronic transaction request from a computing device to a server, for fraud detection. The methods are performed by a computing device and/or a server.

### BACKGROUND OF THE INVENTION

Combating fraud in electronic financial transactions is a significant challenge faced constantly by global financial institutions. Presently, different sets of rules/algorithms are already provided at an issuer end (that is, at the server operated by an issuer of a payment card), as well as at payment processing ends (such as point-of-sale terminals), to assist with fraud detection. Despite that, frauds are still occurring more frequently than ever before, due to difficulties in correctly and accurately identifying and thus preventing occurrence of fraudulent transactions. It is thus important to have improved mechanisms in place to enable efficient identification/prevention of fraudulent transactions, both for transactions at retail locations and for the ubiquitous e-commerce sector.

One object of the present invention is therefore to address at least one of the problems of the prior art and/or to provide a choice that is useful in the art.

### SUMMARY

In general terms, the present invention proposes that a server (typically one operated by a payment card issuing organisation) receives an electronic transaction request including a media access control (MAC) address, and uses the MAC address as part of its process to authorize the request.

According to a 1^{st} aspect of the invention, there is provided a method performed by at least one server for securing an electronic transaction request from a computing device for fraud detection, wherein the request is received as a data packet comprising at least identification data of a payment card associated with the transaction and a MAC address of the computing device, the method comprising: the server comparing the MAC address with at least a first list of MAC addresses to obtain a first determination; the server using the identification data to obtain at least one second determination; and the server transmitting a response to the computing device to accept or decline the request based on the first determination and the at least one second determination.

The first list of addresses may be a “red list” of addresses. If the first determination shows a match between the MAC address in the electronic transaction request and the first list (this possibility is referred to here as the first determination being “positive”), then the response the server transmits to the computing device will be (or will be more likely to be) a signal to decline the request. Conversely, if first determination is “negative” (that is, no match is found in the first list) then the response the server transmits to the computing device may depend solely on the result of the second determination.

The second determination(s) may be any conventional technique for performing request authorization, or an authorization process which is proposed in the future. It may for example, make use of transaction anomalies of the payment card from associated transaction histories, a determination of whether funds are available in a bank account associated with the payment card and/or whether a credit limit associated with the payment card would be exceeded if the transaction request is approved.

A media access control address (MAC address) is a unique identifier assigned to network interfaces for communications on a physical network segment. Conventionally, MAC addresses are assigned by the manufacturer of a network interface controller (NIC) and are stored in its hardware or some other firmware mechanism. If assigned by the manufacturer, a MAC address usually encodes the manufacturer's registered identification number. The MAC address of a given computing device is typically unchanging. This can be contrasted to a programmed address, where the host device issues commands to the NIC to use an arbitrary address.

The method is advantageous in that it enables fraudulent electronic transactions to be identified more accurately, and prevents financial losses arising therefrom. Particularly, it enables the detection and blockage of usage of multiple fraudulent cards from a specific location associated with a MAC address, since hardware/firmware information of the computing device (that is, the MAC address) can be monitored by the server.

Preferably, the data packet further may further include an IP address and Geolocation information of the computing device.

The computing device may be a Point-Of-Sale terminal. Alternatively, the computing device may be one associated with an e-commerce transaction.

Preferably, the data packet may be formatted based on the ISO-8583standard.

Preferably, the MAC address may be stored in a data field of the data packet configured for private use.

Preferably, the data field may be any one of data fields 61 to 63, or 120 to 127 defined by the ISO-8583 standard.

Preferably, transmitting the response may include transmitting a fraud alert to the computing device.

Preferably, the method may further comprise transmitting a further fraud alert to an issuer of the payment card.

Preferably, the method may further comprise including the identification data into the first list if the first determination is positive. In this way, the first list can gradually accumulate identification data for payment cards which have supposedly been used with the computing devices associated with the suspicious MAC addresses.

Preferably, comparing the MAC address may further include comparing the MAC address with a second list of MAC addresses, to form a third determination of whether there is a match. The second list of MAC addresses constitute a “green list”, such that if the third determination is positive (i.e. there is a match) the response transmitted by the server is more likely to be positive (e.g. even if the second determination indicates that the request should not be approved).

Preferably, the method may further comprise including the MAC address into the second list if the second determination is positive. In this way, the second list accumulates identification data for the cards which have been used in the second list of MAC addresses.

According to a 2^{nd} aspect of the invention, there is provided a method performed by a computing device for securing an electronic transaction request for fraud detection, the method comprising: the computing device obtaining at least identification data of a payment card associated with the transaction and a MAC address of the computing device; and the computing device transmitting a data packet to at least one server as the request, wherein the data packet is arranged to include the identification data and MAC address.

According to a 3^{rd} aspect of the invention, there is provided a method for securing an electronic transaction request for fraud detection, the request transmitted as a data packet by a computing device and received by at least one server, the method comprising: the computing device obtaining at least identification data of a payment card associated with the transaction and a MAC address of the computing device; the computing device transmitting the data packet to the server, wherein the data packet is arranged to include the identification data and MAC address; the server comparing the MAC address in the received data packet with at least a list of MAC addresses to obtain a first determination; the server using the identification data in the received data packet to obtain at least one second determination; and the server transmitting a response to the computing device to accept or decline the request based on the first determination and the at least one second determination.

According to a 4^{th} aspect of the invention, there is provided a server for securing an electronic transaction request from a computing device for fraud detection, wherein the request is received as a data packet comprising at least identification data of a payment card associated with the transaction and a MAC address of the computing device, the server comprising: a processor for comparing the MAC address with at least a first list of MAC addresses to obtain a first determination; a detector module for using the identification data to obtain at least one second determination; and a transceiver module for transmitting a response to the computing device to accept or decline the request based on the first determination and the at least one second determination.

According to a 5^{th} aspect of the invention, there is provided a computing device for securing an electronic transaction request for fraud detection, the device comprising: a processor for obtaining at least identification data of a payment card associated with the transaction and a MAC address of the computing device; and a transceiver module for transmitting a data packet to at least one server as the request, wherein the data packet is arranged to include the identification data and MAC address.

According to a 6^{th} aspect of the invention, there is provided a system for securing an electronic transaction request for fraud detection, the request transmitted as a data packet by a computing device and received by at least one server, the system comprising: the computing device which includes: a processor for obtaining at least identification data of a payment card associated with the transaction and a MAC address of the computing device; and a transceiver module for transmitting the data packet to the server, wherein the data packet is arranged to include the identification data and MAC address; and the server which includes: a processor for comparing the MAC address in the received data packet with at least a list of MAC addresses to obtain a first determination; a detector module for using the identification data in the received data packet to obtain at least one second determination; and a transceiver module for transmitting a response to the computing device to accept or decline the request based on the first determination and the at least one second determination.

It should be apparent that features relating to one aspect of the invention may also be applicable to the other aspects of the invention.

These and other aspects of the invention will be apparent from and elucidated with reference to the embodiments described hereinafter.

The term “payment card” is used here to refer in particular to debit or credit cards, ATM cards, and cards storing a pre-paid fixed value, as well as any other device that may hold payment account information, such as mobile phones, smartphones, personal digital assistants (PDAs), key fobs, transponder devices, NFC-enabled devices, and/or computers. If the card is a physical card, the identification data is typically printed on the card. However, the invention is applicable also to cases in which no physical card exists.

### BRIEF DESCRIPTION OF THE DRAWINGS

Embodiments of the invention are disclosed hereinafter with reference to the accompanying drawings, in which:

FIGS. 1a and 1b are respective block diagrams of a computing device and a server, which collectively form an embodiment of the invention, which is a system for processing an electronic transaction request; and

FIG. 2 is a flow diagram of a corresponding method performed by the said system.

### DETAILED DESCRIPTION OF PREFERRED EMBODIMENTS

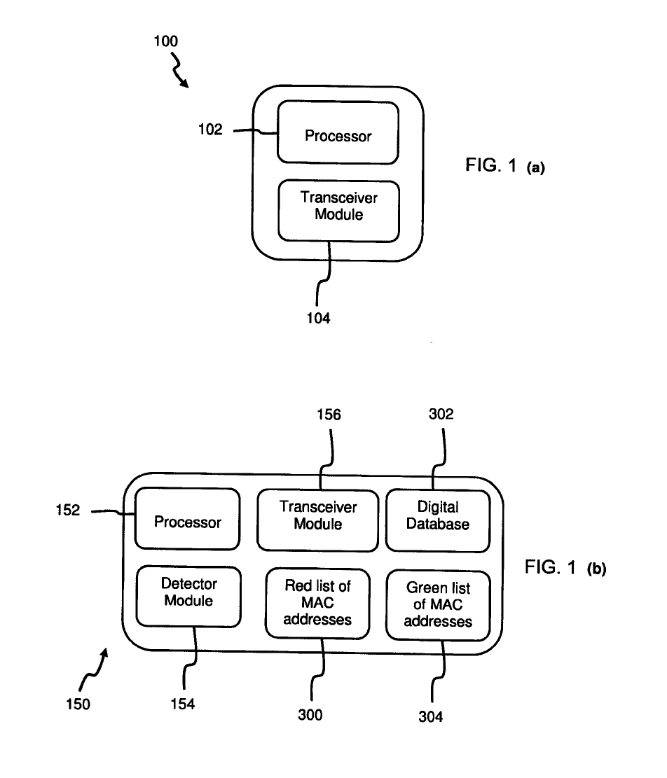

FIGS. 1a and 1b are respective block diagrams of a computing device 100 and a first server 150 (“server”), which collectively form a system for processing an electronic transaction request for fraud detection, according to a first embodiment. The request is transmitted as a data packet by the computing device 100 to the server 150 for processing. The data packet is an Authorization message, formatted based on a recognized standard (to be elaborated below). That is, the server 150 is an authentication and authorization server for accepting/declining the request.

A first example of the computing device 100 is a Point-Of-Sale (POS) terminal. The computing device 100 communicates digitally with the server 150 through a public/private network (e.g. the Internet). It is to be appreciated that a minimum of one server 150 is required, but multiple such similar servers 150 may also be arranged in the system, if necessary.

The computing device 100 includes a processor 102 for obtaining at least identification data of a payment card (not shown) associated with originating the transaction and a MAC address of the computing device 100, and also a transceiver module 104 for transmitting a data packet to the server 150 as the request. The payment card is associated with identification data (i.e. details of the payment card) such as card number, card expiration date, and card security code. In this instance, the computing device formats the data packet based on the ISO-8583 standard, although other suitable standards may also be adopted, depending on requirements of an intended application. The data packet is arranged to include the said identification data of the payment card, and the MAC address of the computing device 100. Under the ISO-8583 standard, the MAC address is arranged to be stored in a data field of the data packet (that is configured for private use), and the data field is any one of data fields 61 to 63, or 120 to 127 as defined by the ISO-8583 standard.

A second example of the computer device 100 is a general purpose computing device, such as a smart-device, laptop, personal computer or the like, which is used by a user to perform an e-commerce transaction by interacting (e.g. over the internet) with (not shown), such as a server operating a retail website. In this case, the processor 102 of the general purpose computer communicates with the second server using the transceiver module 104 to initiate an e-commerce transaction, and sends the second server the MAC address of the computer device 100. In this case, the second server (not the computer device 100 itself) is arranged to send the authorization message to the first server 150 comprising the MAC address of the general purpose computing device. Note that the processing of the authorization message by the first server 150 may be the same in this example as in the example that the computer device 100 is a point-of-sale terminal.

It is also to be appreciated that, in both cases, the computing device 100 may also obtain an IP address and Geolocation information of the computing device 100 for inclusion in any of the above said data fields of the data packet of the transaction request. Moreover, it is to be appreciated that in instances where the computing device 100 is a POS terminal, existing POS terminals may simply be reconfigured (e.g. via software) to capture the MAC address, IP address, Geolocation information and other necessary additional information.

The server 150 includes a processor 152 for comparing the MAC address (provided in the received data packet) with at least a first list 300 of MAC addresses to obtain a first determination; a detector module 154 for performing a conventional transaction request authorization process using the identification data (e.g. by detecting transaction anomalies of the payment card from associated transaction histories using the identification data; or checking that the transaction would not exceed a payment limit associated with the payment card) to obtain at least one second determination; and a transceiver module 156 for receiving the data packet and also transmitting a corresponding response to the computing device 100 to accept/decline the request based on the first determination and the at least one second determination. The detector module 154 may also be termed as a “Fraud detection and tagging engine” in this embodiment.

The first list 300 is a database of MAC addresses associated with previously reported frauds, and of card numbers associated with the respective frauds. It is to be appreciated that the first list 300 of MAC addresses, and a database 302 of any digital data (“digital database”) used in the second determination (e.g. associated transaction histories of the payment card), may reside on the server 150 or in an independent database server electronically accessible by the server 150. The first list 300 of MAC addresses and/or the digital database 302 may be encrypted for security purposes.

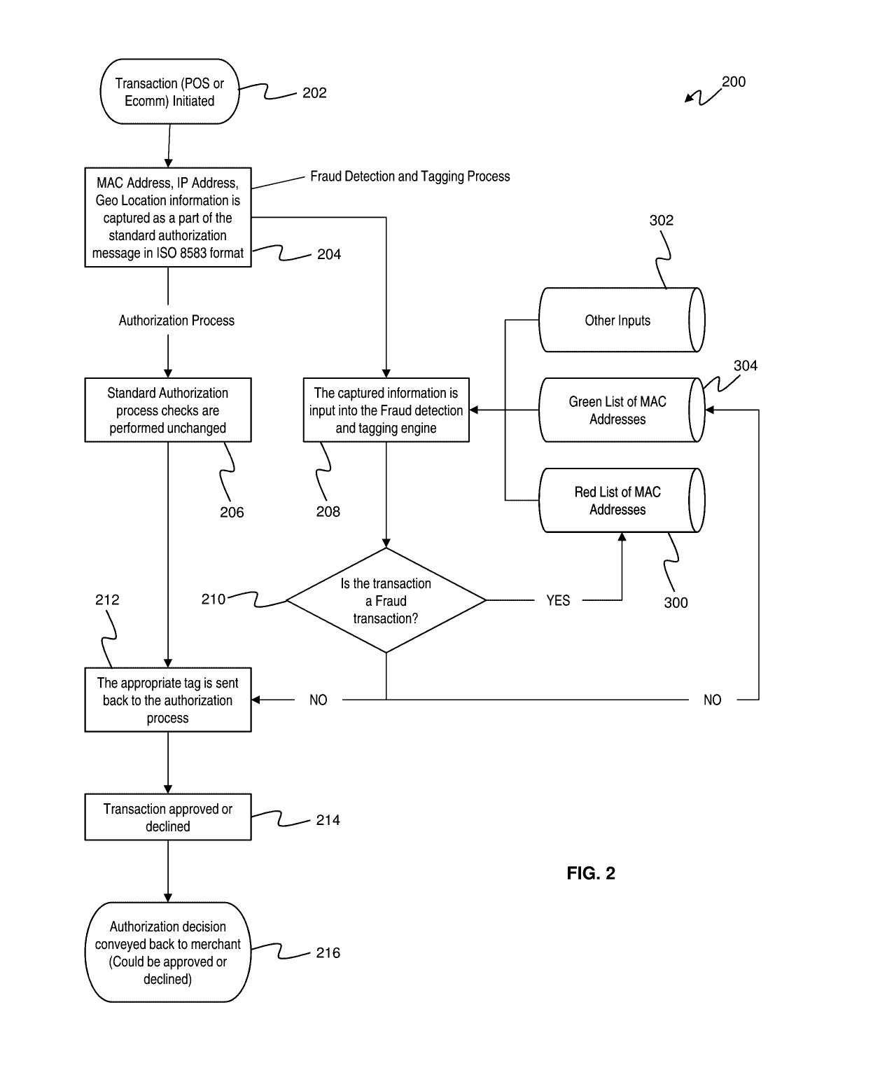

With reference to a flow diagram of FIG. 2, a corresponding method 200 performed by the system (comprising the computing device 100 and server 150) is explained below. The method 200 relates to processing an electronic transaction request for fraud detection. At step 202, an electronic transaction is initiated using the payment card via the computing device 100, and as part of processing of the transaction, identification data of the payment card and MAC address of the computing device 100 are captured by the processor 102 of the computing device 100 in step 204. Next, the computing device 100 stores the captured data into a data packet (formatted as per the ISO-8583 standard) and then transmits the data packet via the transceiver module 104 to the server 150 for processing.

After step 204, the transmitted data packet is received by the transceiver module 156 of the server 150 and processed in step 208 to determine whether the request is a fraudulent transaction. In particular, the received data packet is provided to both the processor 152 and detector module 154 of the server 150 for further processing. The processor 152 of the server 150 determines if the MAC address is present in the first list 300 of MAC addresses. That is, the processor 152 compares the MAC address (stored in the received data packet) with the first list 300 of MAC addresses to obtain a first determination, which is positive if a match is found, but otherwise negative is a match is not found. If the first determination is positive, it may mean that the request is a fraudulent transaction, whereas if the first determination is negative, the converse may then be true. In step 210, the server 150 determines whether the request is a fraudulent transaction based on the first determination.

Specifically, if the request is determined to be a fraudulent transaction (i.e. the first determination is positive), the MAC address of the computing device 100, along with the identification data of the payment card, may then be anonymized and stored encrypted into the first list 300 of MAC addresses. The encrypted data in the first list 300 of MAC addresses is accessible only by authorized programs. The first list 300 of MAC addresses is used as a future reference against other comparisons to be carried out, and may be known as a Red-List of MAC addresses (i.e. includes details of payment cards and computing devices from which fraudulent transactions have been determined to originate from). It is to be appreciated that the first list 300 of MAC addresses may be stored on the server 150 or in a separate database server electronically accessible by the server 150.

Separately, in step 206 the detector module 154 uses the identification data to perform any standard authorization process, which will not be elaborated herein. For example, the detector module 154 may detect any transaction anomalies of the payment card from associated transaction histories (retrieved from the digital database 302) using the identification data (stored in the received data packet) to obtain a second determination (i.e. positive if anomalies are detected, or negative if no anomalies are detected). It is to be appreciated that detecting transaction anomalies here means to check for past spending behaviour under the payment card, and may use the MAC address as one of the criteria. If for example all the transactions for a given payment card have been made using a computing device with a specific MAC address, but if the present transaction is atypical (e.g. in its size) and/or uses a different MAC address, a security procedure may be triggered. For example, a verification alert may be generated, such as sending an SMS or a phone call to the consumer. The authorization process performed in step 206 is an example of what is referred to above as a “second determination” using the identification data of the payment card.

Thereafter, in step 212, an appropriate tag value based on the determination in step 210 is provided to supplement the result of the standard authorization process checks performed in step 206. The tag value may be an authorization response, such as a currently conventional authorization response code which indicates whether the transaction is approved or declined. In step 214, an assessment is made by the server 150 of whether to approve/decline the request by considering the tag value together with other authorization parameters derived in step 206 using the identification data, such as the credit limit of the payment card, or account status of the payment card. A message is sent to the computing device 100 (or, in the case of an e-commerce transaction to the second server) which indicates whether the transaction is approved or declined, as per step 216 set out below. Note that step 214 is performed irrespective of whether the transaction has been determined to be fraudulent.

In step 216, the transceiver module 156 transmits a corresponding response to the computing device 100 to inform that the request is accepted/decline. Needlessly to say, a merchant of the computing device 100 may then act accordingly to accept/decline the electronic transaction.

We now describe an optional feature of the embodiment. Specifically, at step 210, if the request is determined to be a non-fraudulent transaction (i.e. the first determination is negative), the MAC address of the computing device 100, along with the identification data of the payment card, may be anonymized and stored encrypted into a second list 304 of MAC addresses. The encrypted data in the second list 304 of MAC addresses is accessible only by authorized programs. The second list 304 of MAC addresses is used as a future reference against other comparisons to be carried out, and may be known as a Green-List of MAC addresses (i.e. includes details of payment cards and computing devices from which non-fraudulent transactions have been determined to originate from). It is to be appreciated that the second list 304 of MAC addresses may be stored on the server 150 or in a separate database server electronically accessible by the server 150.

The concept of having the Green-List of MAC addresses may be expanded so that respective Green-lists are compiled for respective payment cards. So in this case, a Green-list is defined to be a list of MAC addresses of computing devices, from which genuine electronic transaction requests of a particular payment card originate. Whenever the server 150 receives an electronic transaction request from that particular payment card for approval, the MAC address stored in the received data packet is matched against the corresponding Green-List tagged to the said payment card to provide a quick authorization clearance for that said payment card. It is to be appreciated that the different Green-lists may also be used together with the second list 304 of MAC addresses.

In summary, for fraud detection, the proposed method 200 advantageously uses Authorization messages (formatted based on the ISO-8583 standard) pertaining to electronic transactions request(s) for card payment to capture a MAC address of the computing device 100, from which the request(s) originate, and then includes the MAC address in an associated Authorization message to be generated by the computing device 100. It is to be appreciated that a MAC Address is considered a semi-strong variable to uniquely identify an associated computing device, but a relatively strong variable compared to an IP address. Beneficially, deploying the method 200 only requires slight modifications to setup of the computing device 100 (in the case of a POS terminal) and/or the software installed in the computing device 100 that generates the Authorization message. The MAC address stored in the Authorization message (that is transmitted to the server 150) is then read by the server 150 and utilised in the authentication process for accepting/declining the transaction request. Specifically, the captured MAC address is used by the server 150 to enhance fraud rules/algorithms to enable fraudulent transactions to be flagged in real-time, and thus allow suspicious electronic transaction activities to be identified more efficiently and accurately.

Advantageously, the proposed method 200 enables fraudulent transactions to be identified more accurately, and so prevents financial losses arising therefrom. Further, the proposed method 200 is a much improved method, comparing to conventional solutions, of fraud detection for online transactions and POS transactions. The proposed method 200 may also enable detection and blockage of usage of multiple fraudulent cards from a specific location in concern, since hardware/firmware information (via the MAC address) of the computing device 100 is now monitored. So, unless the computing device 100 at the specific location is subsequently replaced (thus causing the corresponding hardware/firmware information to change), it may be difficult to bypass the fraud detection process provided by the proposed method 200. Furthermore, the proposed method 200, in its preferred embodiments, is compatible with existing systems because communication between the computing device 100 and server 150 is carried out via data packets formatted using the ISO-8583 standard.

For completeness, it is to be appreciated that the MAC address used by the proposed method 200 is different to existing Card Acceptor Terminal IDs in use by MasterCard™. Particularly, Card Acceptor Terminal IDs are configured as semi-permanent IDs that may change as the POS terminals are re-configured. Also, Card acceptor terminal IDs generated by POS terminals in different locations (at which transaction requests originate) may overlap, and thus are not unique (compared to MAC addresses which are unique for different hardware).

While the invention has been illustrated and described in detail in the drawings and foregoing description, such illustration and description are to be considered illustrative or exemplary, and not restrictive; the invention is not limited to the disclosed embodiments. Other variations to the disclosed embodiments can be understood and effected by those skilled in the art in practising the claimed invention.

For example, the processor 152 of the server 150 may also compare the MAC address (stored in the received data packet) with the second list 304 of MAC addresses as part of the first determination for quicker and better matching, and not just restricted to comparing with the first list 300 of MAC addresses. Additionally, in step 216 (of FIG. 2), the transceiver module 156 of the server 150 may also transmit a fraud alert (e.g. an alarm message) to the computing device 100, and/or to an issuer of the payment card. Yet further, at step 208 (of FIG. 2), an IP address of the computing device 100 (if it is a POS terminal) may also be used together with the MAC address for the fraud detection—if the IP address of the computing device 100 changes very frequently, it may be an indication of fraudulent activities possibly being committed through the computing device 100. So, the proposed method 200 offers an even more robust performance for fraud detection when the IP address and MAC address of the computing device 100 are used in combination for fraudulent transactions assessment. Optionally, the second Green-List of MAC addresses may also be compiled for hardware from merchants (handling electronic transactions), and used as a secondary validation reference for the Green-List/Red-List of MAC addresses.

1. A method performed by at least one server for securing an electronic transaction request from a computing device for fraud detection, wherein the request is received as a data packet comprising at least identification data of a payment card associated with the transaction and a MAC address of the computing device, the method comprising:
the server comparing the MAC address with at least a first list of MAC addresses to obtain a first determination;
the server using the identification data to obtain at least one second determination; and
the server transmitting a response to the computing device to accept or decline the request based on the first determination and the at least one second determination.

2. The method of claim 1, wherein the data packet further includes an IP address and Geolocation information of the computing device.

3. The method of claim 1, wherein the computing device includes a Point-Of-Sale terminal.

4. The method of claim 1, wherein the data packet is formatted based on the ISO-8583 standard.

5. The method of claim 4, wherein the MAC address is stored in a data field of the data packet configured for private use.

6. The method of claim 5, wherein the data field is any one of data fields 61 to 63, or 120 to 127 defined by the ISO-8583 standard.

7. The method of claim 1, wherein transmitting the response includes transmitting a fraud alert to the computing device.

8. The method of claim 1, further comprising transmitting a further fraud alert to an issuer of the payment card.

9. The method of claim 1, wherein the first determination is positive if a match of the MAC address is found in the first list of MAC addresses.

10. The method of claim 1, wherein comparing the MAC address further includes comparing the MAC address with a second list of MAC addresses.

11. The method of claim 10, further comprising including the MAC address into the second list if the first determination is negative, wherein the first determination is negative if a match of the MAC address is not found in the first list of MAC addresses.

12. A method performed by a computing device for securing an electronic transaction request for fraud detection, the method comprising:
the computing device obtaining at least identification data of a payment card associated with the transaction and a MAC address of the computing device; and
the computing device transmitting a data packet to at least one server as the request,
wherein the data packet is arranged to include the identification data and MAC address.

13. The method of claim 12, wherein the computing device includes a Point-Of-Sale terminal.

14. The method of claim 12, wherein the data packet is formatted based on the ISO-8583 standard.

15. The method of claim 14, wherein the MAC address is stored in a data field of the data packet configured for private use.

16. The method of claim 15, wherein the data field is any one of data fields 61 to 63, or 120 to 127 defined by the ISO-8583 standard.

17. A method for securing an electronic transaction request for fraud detection, the request transmitted as a data packet by a computing device and received by at least one server, the method comprising:
the computing device obtaining at least identification data of a payment card associated with the transaction and a MAC address of the computing device;
the computing device transmitting the data packet to the server, wherein the data packet is arranged to include the identification data and MAC address;
the server comparing the MAC address in the received data packet with at least a list of MAC addresses to obtain a first determination;
the server using the identification data in the received data packet to obtain at least one second determination; and
the server transmitting a response to the computing device to accept or decline the request based on the first determination and the at least one second determination.

18. A server for securing an electronic transaction request from a computing device for fraud detection, wherein the request is received as a data packet comprising at least identification data of a payment card associated with the transaction and a MAC address of the computing device, the server comprising:
a processor for comparing the MAC address with at least a first list of MAC addresses to obtain a first determination;
a detector module for using the identification data to obtain at least one second determination; and
a transceiver module for transmitting a response to the computing device to accept or decline the request based on the first determination and the at least one second determination

19. A computing device for securing an electronic transaction request for fraud detection, the device comprising:
a processor for obtaining at least identification data of a payment card associated with the transaction and a MAC address of the computing device; and
a transceiver module for transmitting a data packet to at least one server as the request, wherein the data packet is arranged to include the identification data and MAC address.

20. A system for securing an electronic transaction request for fraud detection, the request transmitted as a data packet by a computing device and received by at least one server, the system comprising:
the computing device which includes:
a processor for obtaining at least identification data of a payment card associated with the transaction and a MAC address of the computing device; and
a transceiver module for transmitting the data packet to the server,
wherein the data packet is arranged to include the identification data and MAC address; and
the server which includes:
a processor for comparing the MAC address in the received data packet with at least a list of MAC addresses to obtain a first determination;
a detector module for using the identification data in the received data packet to obtain at least one second determination; and
a transceiver module for transmitting a response to the computing device to accept or decline the request based on the first determination and the at least one second determination.
